(19) United States
(12) Patent Application Publication
(10) Pub. No.: US 2024/0305165 A1
(43) Pub. Date: Sep. 12, 2024

(54) BRUSHLESS MOTOR

(71) Applicant: SONY GROUP CORPORATION, TOKYO (JP)

(72) Inventors: WATARU KOKUBO, TOKYO (JP); HIDEO MIYANO, TOKYO (JP); TATSUO MAKII, TOKYO (JP); MASAHARU SAKATA, TOKYO (JP)

(21) Appl. No.: 18/550,456

(22) PCT Filed: Jan. 28, 2022
(86) PCT No.: PCT/JP2022/003259

§ 371 Date: Sep. 13, 2023

(30) Foreign Application Priority Data
Mar. 25, 2021 (JP) 2021-051640

(51) Int. Cl. H02K 7/08; H02K 1/2786

(52) U.S. Cl. CPC H02K 7/086; H02K 1/2786

(57) ABSTRACT

A brushless motor (1) according to the present disclosure includes a rotor base (20), a stator core (50), and a first bearing (60), and a second bearing (70). The rotor base (20) supports a magnet (30). The stator core (50) is disposed to face the magnet (30) in a radial direction. The first bearing (60) and the second bearing (70) rotatably support the rotor base (20) directly or indirectly. The stator core (50) is disposed between the first bearing (60) and the second bearing (70) in an axial direction.

### FIELD

The present disclosure relates to a brushless motor.

### BACKGROUND

Conventionally, an outer rotor type brushless motor in which a rotor is disposed outside a stator core has been known (refer to Patent Literature 1).

### CITATION LIST

### Patent Literature

Patent Literature 1: JP 2017-118810 A

### SUMMARY

### Technical Problem

The present disclosure proposes a brushless motor that can be downsized.

### Solution to Problem

According to the present disclosure, there is provided a brushless motor. The brushless motor includes a rotor base, a stator core, and a first bearing, and a second bearing. The rotor base supports a magnet. The stator core is disposed to face the magnet in a radial direction. The first bearing and the second bearing rotatably support the rotor base directly or indirectly. The stator core is disposed between the first bearing and the second bearing in an axial direction.

### BRIEF DESCRIPTION OF DRAWINGS

FIG. 1 is a cross-sectional view illustrating a configuration of a brushless motor according to an embodiment of the present disclosure.

FIG. 2 is a cross-sectional view illustrating a configuration of a brushless motor in a reference example of the present disclosure.

FIG. 3 is a cross-sectional view illustrating a configuration of a brushless motor according to a first modification of the embodiment of the present disclosure.

FIG. 4 is a cross-sectional view illustrating a configuration of a brushless motor according to a second modification of the embodiment of the present disclosure.

FIG. 5 is a cross-sectional view illustrating a configuration of a brushless motor according to a third modification of the embodiment of the present disclosure.

### DESCRIPTION OF EMBODIMENTS

Hereinafter, each embodiment of the present disclosure will be described in detail with reference to the drawings. In each of the following embodiments, the same parts are denoted by the same reference numerals, and redundant description will be omitted.

Conventionally, an outer rotor type brushless motor in which a rotor base is disposed outside a stator core has been known. The brushless motor includes a magnet supported by the rotor base and radially opposed to the stator core, and a pair of bearings configured to rotatably support a shaft.

However, in the above-described conventional technique, since the stator core is disposed outside one bearing and the magnet is disposed outside the stator core, it is difficult to reduce the size in the radial direction.

Therefore, it is expected to achieve a technique capable of overcoming the above-described problems and miniaturizing the brushless motor. [Embodiment]

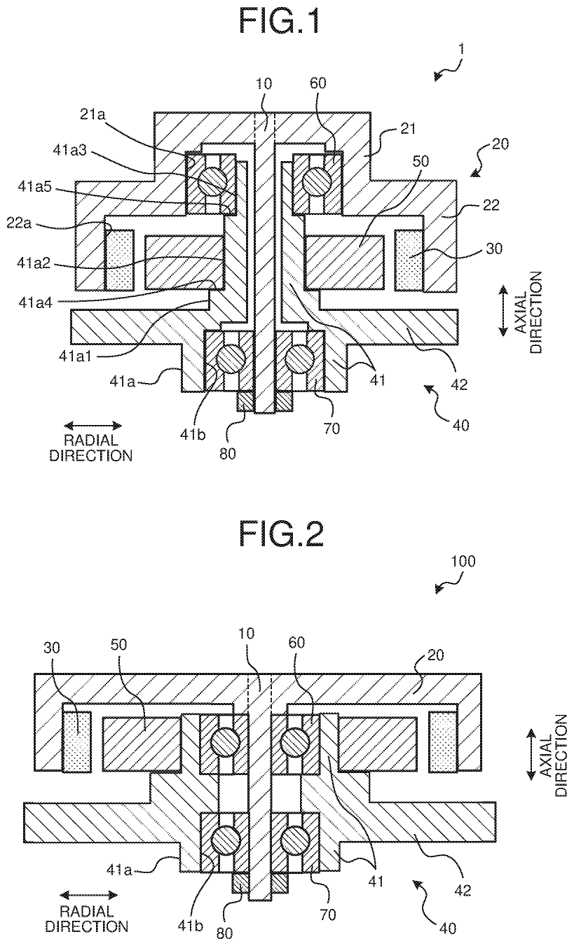

First, a configuration of a brushless motor 1 according to an embodiment will be described with reference to FIGS. 1 and 2. FIG. 1 is a cross-sectional view illustrating a configuration of the brushless motor 1 according to the embodiment of the present disclosure.

As illustrated in FIG. 1, the brushless motor 1 according to the embodiment is an outer rotor type brushless motor having a stator at the center and a rotor around the stator.

The brushless motor 1 according to the embodiment includes a shaft 10, a rotor base 20, a magnet 30, a stator base 40, a stator core 50, a first bearing 60, a second bearing 70, and a retaining member 80.

The rotor of the brushless motor 1 according to the embodiment includes the shaft 10, the rotor base 20, and the magnet 30. The stator of the brushless motor 1 according to the embodiment includes the stator base 40 and the stator core 50.

The shaft 10 has, for example, a rod shape, is located at the rotation center of the brushless motor 1, and extends in the axial direction of the brushless motor 1. In other words, the direction in which the rod-shaped shaft 10 extends is the axial direction in the brushless motor 1.

The rotor base 20 is a rotating body (rotor) in the brushless motor 1, and has a substantially cylindrical shape in which the distal end side of the brushless motor 1 in the axial direction is closed. In the example of FIG. 1, the rotor base 20 is formed to be integrated with the shaft 10.

In the present disclosure, the “proximal end side” refers to a side (lower side in the drawing) on which the retaining member 80 is disposed with respect to the first bearing 60 and the second bearing 70 in the axial direction, and the “distal end side” refers to a side (upper side in the drawing) opposite the proximal end side in the axial direction.

The rotor base 20 includes a narrow diameter portion 21 and an enlarged diameter portion 22. The narrow diameter portion 21 is a portion having a diameter smaller than that of the enlarged diameter portion 22, and is directly supported by the shaft 10. The enlarged diameter portion 22 is a portion having a diameter larger than that of the narrow diameter portion 21, and is supported on the proximal end side of the narrow diameter portion 21.

The magnet 30 has, for example, a cylindrical shape, and is fixed to an inner peripheral surface 22a of the enlarged diameter portion 22 of the rotor base 20. On the inner peripheral surface of the magnet 30, a plurality of magnetic poles (not illustrated) in which S poles and N poles are alternately magnetized in the circumferential direction are formed.

The stator base 40 supports the stator core 50 to be described later. The stator base 40 includes a cylindrical portion 41 and a plate-shaped portion 42. The cylindrical portion 41 has a substantially cylindrical shape in which the proximal end side is widened, and the shaft 10 is inserted thereinto.

The distal end side of the cylindrical portion 41 has a stepped shape on an outer peripheral surface 41a. Specifically, the outer peripheral surface 41a of the cylindrical portion 41 has a first portion 41a1, a second portion 41a2, a third portion 41a3, a first step portion 41a4, and a second step portion 41a5.

The first portion 41a1 is a portion having a larger diameter than those of the second portion 41a2 and the third portion 41a3, and is located closer to the proximal end side of the brushless motor 1 than the second portion 41a2 and the third portion 41a3.

The second portion 41a2 is a portion having a smaller diameter than that of the first portion 41a1 and a larger diameter than that of the third portion 41a3, and is located between the first portion 41a1 and the third portion 41a3.

The third portion 41a3 is a portion having a smaller diameter than those of the first portion 41a1 and the second portion 41a2, and is located closer to the distal end side of the cylindrical portion 41 than the first portion 41a1 and the second portion 41a2.

The first step portion 41a4 is located between the first portion 41a1 and the second portion 41a2, and has a surface substantially perpendicular to the axial direction. The second step portion 41a5 is located between the second portion 41a2 and the third portion 41a3, and has a surface substantially perpendicular to the axial direction.

The plate-shaped portion 42 of the stator base 40 has a substantially annular shape, is located closer to the proximal end side than the first portion 41a1 of the cylindrical portion 41, and is disposed so as to cover an opening on the proximal end side of the rotor base 20. The plate-shaped portion 42 has a function of protecting the magnet 30 and the stator core 50 so that a foreign matter or the like does not enter the magnet 30 and the stator core 50 accommodated in the brushless motor 1 from the outside.

The stator core 50 generates a magnetic field for rotating the magnet 30. The stator core 50 includes, for example, a plurality of cores (not illustrated) formed to protrude radially in the radial direction, and a plurality of stator coils (not illustrated) wound around the plurality of cores, respectively. When a voltage is applied to the plurality of stator coils, the stator core 50 generates a magnetic field for rotating the magnet 30.

The stator core 50 has a substantially cylindrical shape as a whole, and is fixed to the outer peripheral surface 41a of the cylindrical portion 41 in the stator base 40. Specifically, the stator core 50 is fixed on the outer peripheral surface 41a of the cylindrical portion 41 so as to be in contact with the second portion 41a2 and the first step portion 41a4.

That is, the inner diameter of the stator core 50 according to the embodiment is smaller than the outer diameter of the first portion 41a1 of the cylindrical portion 41 in the stator base 40 and larger than the outer diameter of the second portion 41a2 of the cylindrical portion 41.

The first bearing 60 is a substantially annular rolling bearing, for example, a ball bearing. The first bearing 60 is fixed to the outer peripheral surface 41a of the cylindrical portion 41 in the stator base 40.

Specifically, the first bearing 60 is fixed so that the inner ring of the first bearing 60 is in contact with the third portion 41a3 and the second step portion 41a5 on the outer peripheral surface 41a of the cylindrical portion 41. Furthermore, in the first bearing 60, the outer ring of the first bearing 60 is fixed to an inner peripheral surface 21a of the narrow diameter portion 21 of the rotor base 20.

The second bearing 70 is a substantially annular rolling bearing, for example, a ball bearing. The second bearing 70 is fixed to an inner peripheral surface 41b of the cylindrical portion 41 of the stator base 40.

Specifically, the second bearing 70 is fixed so that the outer ring of the second bearing 70 is in contact with the surface closer to the proximal end side than to the first portion 41a1 on the inner peripheral surface 41b of the cylindrical portion 41. Furthermore, in the second bearing 70, the inner ring of the second bearing 70 is fixed to the side surface of the shaft 10.

The retaining member 80 is in contact with the surface on the proximal end side of the inner ring of the second bearing 70 and is fixed to the shaft 10. The retaining member 80 prevents the shaft 10 from coming off to the distal end side of the brushless motor 1. The retaining member 80 is, for example, a nut or an E-ring.

Here, in the embodiment, as illustrated in FIG. 1, the stator core 50 is disposed between the first bearing 60 and the second bearing 70 in the axial direction of the brushless motor 1. As a result, in the embodiment, miniaturization in the radial direction can be realized. The reason will be described below.

FIG. 2 is a cross-sectional view illustrating a configuration of a brushless motor 100 in a reference example of the present disclosure. The brushless motor 100 of the reference example is different from that of the embodiment in the relative positions of the stator core 50, the first bearing 60, and the second bearing 70.

Specifically, in the reference example, the first bearing 60 and the second bearing 70 are disposed between the shaft 10 and the inner peripheral surface 41b of the cylindrical portion 41 in the stator base 40. The stator core 50 is disposed outside the first bearing 60 (the outer peripheral surface 41a of the cylindrical portion 41).

When the brushless motor 100 has such a configuration, the inner diameter of the stator core 50 must be larger than the outer diameter of the first bearing 60. That is, in the reference example, the size of the stator core 50 is limited by the size of the first bearing 60.

Furthermore, in the reference example, since the magnet 30 and the like are disposed outside the stator core 50, it is difficult to realize miniaturization in the radial direction in the brushless motor 100 of the reference example.

On the other hand, in the embodiment, since the stator core 50 is disposed between the first bearing 60 and the second bearing 70 in the axial direction, the size of the stator core 50 can be reduced without being limited by the size of the first bearing 60. Therefore, according to the embodiment, it is possible to realize the brushless motor 1 that can be downsized.

Further, in the reference example illustrated in FIG. 2, since a distance between the first bearing 60 and the second bearing 70 is short, the rotation axis may be inclined if concentricity between the first bearing 60 and the second bearing 70 is low. If the rotation axis is inclined in this manner, the rotor base 20 may not be smoothly rotated.

That is, in the reference example illustrated in FIG. 2, since significantly high concentricity is required between the first bearing 60 and the second bearing 70, there is a possibility that manufacturing costs increase in order to realize this significantly high concentricity.

On the other hand, in the embodiment, since the stator core 50 is disposed between the first bearing 60 and the second bearing 70, the distance between the first bearing 60 and the second bearing 70 can be increased as compared with the reference example of FIG. 2. As a result, even if the concentricity between the first bearing 60 and the second bearing 70 is not so high, the rotor base 20 can be smoothly rotated.

Therefore, according to the embodiment, since the stator core 50 is disposed between the first bearing 60 and the second bearing 70, manufacturing costs can be reduced.

In addition, the brushless motor 1 according to the embodiment may be an outer rotor type brushless motor in which the rotor base 20 is disposed outside the stator core 50. As a result, it is not necessary to downsize the magnet 30, and the stator coil of the stator core 50 can be easily manufactured, so that manufacturing costs of the brushless motor 1 can be reduced.

In the embodiment, the first bearing 60 may be supported by the outer peripheral surface 41a of the cylindrical portion 41, and the second bearing 70 may be supported by the inner peripheral surface 41b of the cylindrical portion 41. As a result, the outer diameter of the third portion 41a3 where the first bearing 60 is located can be made smaller than that of the second portion 41a2 where the stator core 50 is located.

Since the outer diameter of the third portion 41a3 can be made smaller than that of the second portion 41a2, the stator core 50 can be easily inserted into the second portion 41a2 from the distal end side of the cylindrical portion 41. That is, in the embodiment, since the first bearing 60 is supported by the outer peripheral surface 41a of the cylindrical portion 41, the stator core 50 can be easily disposed between the first bearing 60 and the second bearing 70 even when the cylindrical portion 41 is integrally formed.

In the embodiment, the outer peripheral surface 41a of the cylindrical portion 41 may include the first portion 41a1 having an outer diameter larger than the inner diameter of the stator core 50, the second portion 41a2 having an outer diameter smaller than the inner diameter of the stator core 50, and the first step portion 41a4 located between the two portions.

In the embodiment, since the stator core 50 is supported by the stator base 40 so as to be in contact with the first step portion 41a4, it is possible to more accurately position the stator core 50 inside the brushless motor 1.

In the embodiment, the outer peripheral surface 41a of the cylindrical portion 41 may include the second portion 41a2 having an outer diameter larger than the inner diameter of the first bearing 60, the third portion 41a3 having an outer diameter smaller than the inner diameter of the first bearing 60, and the second step portion 41a5 located between the two portions.

In the embodiment, since the first bearing 60 is supported by the stator base 40 so as to be in contact with the second step portion 41a5, the positioning of the first bearing 60 in the brushless motor 1 can be performed more accurately.

Additionally, in the embodiment, the retaining member 80 configured to prevent the shaft 10 from coming out of the cylindrical portion 41 of the stator base 40 may be provided. As a result, it is possible to prevent the rotor base 20 from being detached from the brushless motor 1 when the brushless motor 1 is used, so that reliability of the brushless motor 1 can be improved.

Further, in the embodiment, preload may be applied to the first bearing 60 and the second bearing 70 in the axial direction by using the retaining member 80. As a result, rattling of the balls in the first bearing 60 and the second bearing 70 can be suppressed, so that rattling of the rotor base 20 can be suppressed.

For example, when the retaining member 80 is formed of a nut, preload can be applied to the first bearing 60 and the second bearing 70 by tightening the nut with respect to the shaft 10 having a spiral groove formed therein.

When the retaining member 80 is formed of an E-ring, the shaft 10 may be bonded to the inside of the second bearing 70 in a state where preload is applied to the first bearing 60 and the second bearing 70 in advance. In the embodiment, as a safety measure when the adhesive peels off, a groove (not illustrated) may be provided in the shaft 10, and the E-ring may be press-fitted and fixed from the side.

In addition, in the embodiment, in a case where assembly can be performed at a position of a groove where preload can be applied only by fixing the E-ring, only the E-ring may be press-fitted and fixed. Accordingly, the retaining member 80 can apply preload to the first bearing 60 and the second bearing 70.

### Various Modifications

### First Modification

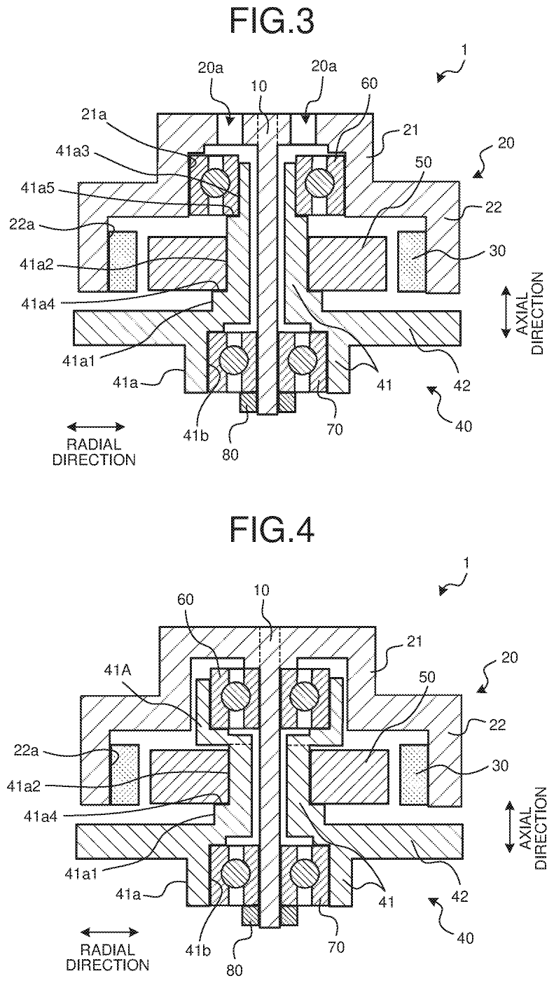

Next, various modifications of the embodiment will be described with reference to FIGS. 3 to 5. FIG. 3 is a cross-sectional view illustrating a configuration of a brushless motor 1 according to a first modification of the embodiment of the present disclosure. As illustrated in FIG. 3, in the first modification, the rotor base 20 has a plurality of through holes 20a on the end surface on the distal end side. The plurality of through holes 20a expose a part of the first bearing 60 in the axial direction.

In the first modification, by using the plurality of through holes 20a, the yield of the brushless motor 1 can be improved by an assembly process described below.

Specifically, first, an operator fixes the stator core 50 to the stator base 40, and fixes the magnet 30 and the first bearing 60 to the rotor base 20. In the present disclosure, the “operator” includes a robot and the like.

Next, the operator covers the stator base 40 with the rotor base 20, inserts the shaft 10 into the cylindrical portion 41 of the stator base 40, and press-fits the first bearing 60 into the cylindrical portion 41.

At this time, the operator inserts a plurality of pins (not illustrated) into the plurality of through holes 20a, and directly presses the first bearing 60 in the axial direction by the plurality of pins. As a result, it is possible to suppress excessive pressure from being applied to the first bearing 60 at the time of press-fitting as compared with a case where the first bearing 60 is indirectly pressed via the rotor base 20.

Therefore, according to the first modification, it is possible to suppress the first bearing 60 from being damaged during the assembly process, and thus, it is possible to improve the yield of the brushless motor 1.

The plurality of through holes 20a may be arranged with an equal gap interposed therebetween in the circumferential direction. For example, when three through holes 20a are provided in the rotor base 20, the three through holes 20a may be arranged at intervals of 120° in the circumferential direction.

As a result, since the bias of force applied by the plurality of pins can be suppressed, it is possible to further suppress excessive pressure from being applied to the first bearing 60 when the first bearing 60 is press-fitted into the cylindrical portion 41. Therefore, according to the first modification, the yield of the brushless motor 1 can be further improved.

### Second Modification

FIG. 4 is a cross-sectional view illustrating a configuration of a brushless motor 1 according to a second modification of the embodiment of the present disclosure. In the second modification, the arrangement of the first bearing 60 with respect to the stator base 40 is different from those in the above-described embodiment and first modification.

Specifically, as illustrated in FIG. 4, the cylindrical portion 41 of the stator base 40 has an enlarged diameter portion 41A. The enlarged diameter portion 41A is a portion located closer to the distal end side than the second portion 41a2, the portion having a diameter larger than that of the second portion 41a2.

The first bearing 60 is fixed to the inner peripheral surface 41b of the enlarged diameter portion 41A. Furthermore, in the first bearing 60, the inner peripheral surface of the first bearing 60 is fixed to the side surface of the shaft 10.

Even with such a configuration, in the second modification, since the stator core 50 is disposed between the first bearing 60 and the second bearing 70 in the axial direction, the size of the stator core 50 can be reduced without being limited by the size of the first bearing 60. Therefore, according to the second modification, it is possible to realize the brushless motor 1 that can be downsized.

In the case of assembling the brushless motor 1 having the configuration of the second modification, the stator base 40 may be configured so that the enlarged diameter portion 41A and a main body portion (portion other than the enlarged diameter portion 41A) are formed separately. After the stator core 50 is fixed to the main body portion, the enlarged diameter portion 41A may be fixed to the main body portion.

### Third Modification

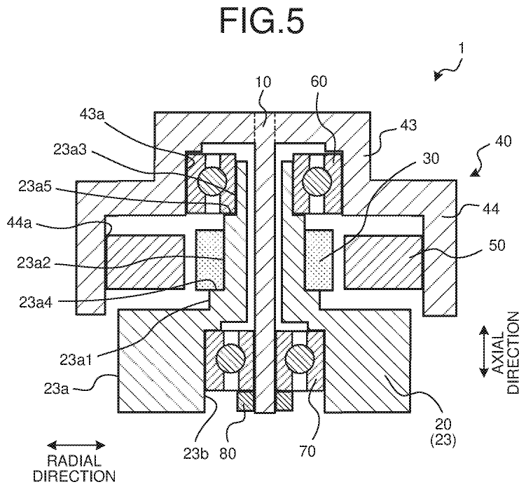

In the embodiment and the first and second modifications described above, a description has been given as to an example in which the brushless motor 1 is an outer rotor type brushless motor, but the present disclosure is not limited to such an example. FIG. 5 is a cross-sectional view illustrating a configuration of a brushless motor 1 according to a third modification of the embodiment of the present disclosure.

As illustrated in FIG. 5, the brushless motor 1 according to the third modification is an inner rotor type brushless motor having a rotor at the center and a stator around the rotor.

The brushless motor 1 according to the third modification includes a shaft 10, a rotor base 20, a magnet 30, a stator base 40, a stator core 50, a first bearing 60, a second bearing 70, and a retaining member 80.

The shaft 10 has, for example, a rod shape, is located at the rotation center of the brushless motor 1, and extends in the axial direction of the brushless motor 1.

The rotor base 20 supports the magnet 30. The rotor base 20 has a cylindrical portion 23. The cylindrical portion 23 has a substantially cylindrical shape in which the proximal end side is widened, and the shaft 10 is inserted thereinto.

The distal end side of the cylindrical portion 23 has a stepped shape on an outer peripheral surface 23a.

Specifically, the outer peripheral surface 23a of the cylindrical portion 23 has a first portion 23al, a second portion 23a2, a third portion 23a3, a first step portion 23a4, and a second step portion 23a5.

The first portion 23a1 is a portion having a larger diameter than those of the second portion 23a2 and the third portion 23a3, and is located closer to the proximal end side of the brushless motor 1 than the second portion 23a2 and the third portion 23a3.

The second portion 23a2 is a portion having a smaller diameter than that of the first portion 23a1 and a larger diameter than that of the third portion 23a3, and is located between the first portion 23a1 and the third portion 23a3.

The third portion 23a3 is a portion having a smaller diameter than those of the first portion 23a1 and the second portion 23a2, and is located closer to the distal end side of the cylindrical portion 23 than the first portion 23a1 and the second portion 23a2.

The first step portion 23a4 is located between the first portion 23a1 and the second portion 23a2 and has a surface substantially perpendicular to the axial direction. The second step portion 23a5 is located between the second portion 23a2 and the third portion 41a3 and has a surface substantially perpendicular to the axial direction.

The magnet 30 has, for example, a cylindrical shape, and is fixed to the second portion 23a2 of the cylindrical portion 23 of the rotor base 20. On the outer peripheral surface of the magnet 30, a plurality of magnetic poles (not illustrated) in which S poles and N poles are alternately magnetized in the circumferential direction are formed.

The stator base 40 supports the stator core 50 to be described later, and has a substantially cylindrical shape in which the distal end side of the brushless motor 1 in the axial direction is closed. In the third modification, the stator base 40 is formed to be integrated with the shaft 10.

Further, the stator base 40 includes a narrow diameter portion 43 and an enlarged diameter portion 44. The narrow diameter portion 43 is a portion having a diameter smaller than that of the enlarged diameter portion 44, and is directly supported by the shaft 10. The enlarged diameter portion 44 is a portion having a diameter larger than that of the narrow diameter portion 43, and is supported by the narrow diameter portion 43.

The stator core 50 generates a magnetic field for rotating the magnet 30. The stator core 50 includes, for example, a plurality of cores (not illustrated) formed to protrude toward the rotation center and a plurality of stator coils (not illustrated) wound around the plurality of cores, respectively.

When a voltage is applied to the plurality of stator coils, the stator core 50 generates a magnetic field for rotating the magnet 30. The stator core 50 is fixed to an inner peripheral surface 44a of the enlarged diameter portion 44 of the stator base 40.

The first bearing 60 is a substantially annular rolling bearing, for example, a ball bearing. The first bearing 60 is fixed to the outer peripheral surface 23a of the cylindrical portion 23 in the rotor base 20.

Specifically, the first bearing 60 is fixed so that the inner ring of the first bearing 60 is in contact with the third portion 23a3 and the second step portion 23a5 on the outer peripheral surface 23a of the cylindrical portion 23. Further, in the first bearing 60, the outer ring of the first bearing 60 is fixed to a inner peripheral surface 43a of the narrow diameter portion 43 of the stator base 40.

The second bearing 70 is a substantially annular rolling bearing, for example, a ball bearing. The second bearing 70 is fixed to an inner peripheral surface 23b of the cylindrical portion 23 in the rotor base 20.

Specifically, the second bearing 70 is fixed so that the outer ring of the second bearing 70 is in contact with the surface closer to the proximal end side than the first portion 23a1 on the inner peripheral surface 23b of the cylindrical portion 23. Furthermore, in the second bearing 70, the inner ring of the second bearing 70 is fixed to the side surface of the shaft 10.

The retaining member 80 is in contact with the surface on the proximal end side of the inner ring of the second bearing 70 and is fixed to the shaft 10. The retaining member 80 prevents the shaft 10 from coming off to the distal end side of the brushless motor 1. The retaining member 80 is, for example, a nut or an E-ring. In the third modification having such a

configuration, since the stator core 50 is disposed between the first bearing 60 and the second bearing 70 in the axial direction, the size of the stator core 50 can be reduced without being limited by the size of the first bearing 60. Therefore, according to the third modification, it is possible to realize the inner rotor type brushless motor 1 that can be downsized.

In the third modification, similarly to the embodiment, the stator core 50 is disposed between the first bearing 60 and the second bearing 70, thereby making it possible to increase the distance between the first bearing 60 and the second bearing 70. As a result, even if the concentricity between the first bearing 60 and the second bearing 70 is not so high, the rotor base 20 can be smoothly rotated.

Therefore, according to the third modification, since the stator core 50 is disposed between the first bearing 60 and the second bearing 70, manufacturing costs can be reduced.

In addition, the brushless motor 1 according to the third modification may be an inner rotor type brushless motor in which the rotor base 20 is disposed inside the stator core 50. As a result, the moment of inertia of the rotor base 20 can be reduced, and the heat dissipation of the stator core 50 can be improved.

Further, in the third modification, the first bearing 60 may be supported by the outer peripheral surface 23a of the cylindrical portion 23, and the second bearing 70 may be supported by the inner peripheral surface 23b of the cylindrical portion 23. As a result, the outer diameter of the third portion 23a3 where the first bearing 60 is located can be made smaller than that of the second portion 41a2 where the magnet 30 is located.

Since the outer diameter of the third portion 23a3 can be made smaller than that of the second portion 23a2, the magnet 30 can be easily inserted into the second portion 23a2 from the distal end side of the cylindrical portion 23. That is, in the third modification, since the first bearing 60 is supported by the outer peripheral surface 23a of the cylindrical portion 23, the magnet 30 can be easily disposed between the first bearing 60 and the second bearing 70 even when the cylindrical portion 23 is integrally formed.

Furthermore, in the third modification, the outer peripheral surface 23a of the cylindrical portion 23 may include the first portion 23a1 having an outer diameter larger than the inner diameter of the magnet 30, the second portion 23a2 having an outer diameter smaller than the inner diameter of the magnet 30, and the first step portion 23a4 located between the two portions.

In the third modification, since the magnet 30 is supported by the rotor base 20 so as to be in contact with the first step portion 23a4, the positioning of the magnet 30 in the brushless motor 1 can be performed more accurately.

In the third modification, the outer peripheral surface 23a of the cylindrical portion 23 may include the second portion 23a2 having an outer diameter larger than the inner diameter of the first bearing 60, the third portion 23a3 having an outer diameter smaller than the inner diameter of the first bearing 60, and the second step portion 23a5 located between the two portions.

In the third modification, since the first bearing 60 is supported by the rotor base 20 so as to be in contact with the second step portion 23a5, it is possible to more accurately position the first bearing 60 inside the brushless motor 1.

### Effects

The brushless motor 1 according to the embodiment includes the rotor base 20, the stator core 50, the first bearing 60, and the second bearing 70. The rotor base 20 supports the magnet 30. The stator core 50 is disposed to face the magnet 30 in the radial direction. The first bearing 60 and the second bearing 70 rotatably support the rotor base 20 directly or indirectly. The stator core 50 is disposed between the first bearing 60 and the second bearing 70 in the axial direction.

As a result, manufacturing costs of the brushless motor 1 can be reduced.

In the brushless motor 1 according to the embodiment, the rotor base 20 is disposed outside the stator core 50.

Accordingly, downsizing in the radial direction can be realized.

Further, the brushless motor 1 according to the embodiment further includes the shaft 10 formed to be integrated with the rotor base 20, and the stator base 40 that supports the stator core 50 and has the cylindrical portion 41 having the shaft 10 inserted thereinto. The first bearing 60 is supported by the outer peripheral surface 41a of the cylindrical portion 41 and rotatably supports the rotor base 20, and the second bearing 70 is supported by the inner peripheral surface 41b of the cylindrical portion 41 and rotatably supports the shaft 10.

Accordingly, even when the cylindrical portion 41 is integrally formed, the stator core 50 can be easily disposed between the first bearing 60 and the second bearing 70.

Further, in the brushless motor 1 according to the embodiment, the outer peripheral surface 41a of the cylindrical portion 41 includes the first portion 41al, the second portion 41a2, and the first step portion 41a4. The first portion 41a1 has an outer diameter larger than the inner diameter of the stator core 50. The second portion 41a2 has an outer diameter smaller than the inner diameter of the stator core 50. The first step portion 41a4 is located between the first portion 41a1 and the second portion 41a2. Additionally, the stator core 50 is supported so as to be in contact with the first step portion 41a4.

As a result, it is possible to position the stator core 50 in the brushless motor 1 more accurately.

In the brushless motor 1 according to the embodiment, the outer diameter of the second portion 41a2 is larger than the inner diameter of the first bearing 60. Furthermore, the outer peripheral surface 41a of the cylindrical portion 41 includes the third portion 41a3 having an outer diameter smaller than the inner diameter of the first bearing 60, and the second step portion 41a5 located between the second portion 41a2 and the third portion 41a3. Further, the first bearing 60 is supported so as to be in contact with the second step portion 41a5.

Accordingly, the positioning of the first bearing 60 in the brushless motor 1 can be performed more accurately.

In addition, the brushless motor 1 according to the embodiment further includes the retaining member 80 located on a surface of the second bearing 70, the surface is located opposite the first bearing 60, and configured to prevent the shaft 10 from coming off.

Accordingly, reliability of the brushless motor 1 can be improved.

Further, in the brushless motor 1 according to the embodiment, the retaining member 80 applies preload to the first bearing 60 and the second bearing 70.

Accordingly, rattling of the rotor base 20 can be suppressed.

In addition, in the brushless motor 1 according to the first modification, the rotor base 20 includes a plurality of through holes 20a configured to expose a part of the first bearing 60 in the axial direction.

Accordingly, the yield of the brushless motor 1 can be improved.

In addition, the brushless motor 1 according to the second modification further includes the shaft 10 formed to be integrated with the rotor base 20, and the stator base 40 that supports the stator core 50 and has the cylindrical portion 41 through which the shaft 10 is inserted. Further, the first bearing 60 and the second bearing 70 are supported by the inner peripheral surface 41b of the cylindrical portion 41 and rotatably support the shaft 10.

Accordingly, downsizing in the radial direction can be realized.

Further, in the brushless motor 1 according to the third modification, the rotor base 20 is disposed inside the stator core 50.

As a result, the moment of inertia of the rotor base 20 can be reduced, and the heat dissipation of the stator core 50 can be improved.

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

For example, in the above-described embodiments, an example in which the technology of the present disclosure is applied to a brushless motor has been described, but the motor to which the technology of the present disclosure is applied is not limited to a brushless motor, and the technology of the present disclosure may be applied to motors of various types.

Furthermore, the effects described in the present specification are merely examples and are not limited, and other effects may be obtained.

It is noted that the present technology can also have the following configurations.
(1)

A brushless motor comprising:
a rotor base configured to support a magnet;
a stator core disposed to face the magnet in a radial direction; and
a first bearing and a second bearing configured to rotatably support the rotor base directly or indirectly, wherein the stator core is disposed between the first bearing and the second bearing in an axial direction.
(2)

The brushless motor according to the above (1), wherein the rotor base is disposed outside the stator core.
(3)

The brushless motor according to the above (2), further comprising:
a shaft formed to be integrated with the rotor base; and
a stator base configured to support the stator core, the stator base having a cylindrical portion through which the shaft is inserted,
wherein the first bearing is supported by an outer peripheral surface of the cylindrical portion and rotatably supports the rotor base, and
wherein the second bearing is supported by an inner peripheral surface of the cylindrical portion and rotatably supports the shaft.
(4)

The brushless motor according to the above (3),
wherein the outer peripheral surface of the cylindrical portion includes a first portion having an outer diameter larger than an inner diameter of the stator core, a second portion having an outer diameter smaller than the inner diameter of the stator core, and a first step portion located between the first portion and the second portion, and
wherein the stator core is supported so as to be in contact with the first step portion.
(5)

The brushless motor according to the above (4),
wherein the second portion has the outer diameter larger than an inner diameter of the first bearing,
wherein the outer peripheral surface of the cylindrical portion includes a third portion having an outer diameter smaller than the inner diameter of the first bearing, and a second step portion located between the second portion and the third portion, and
wherein the first bearing is supported so as to be in contact with the second step portion.
(6)

The brushless motor according to any one of the above (3) to (5), further comprising a retaining member located on a surface of the second bearing, the surface is located opposite the first bearing, and configured to prevent the shaft from coming off.
(7)

The brushless motor according to the above (6), wherein the retaining member applies preload to the first bearing and the second bearing.
(8)

The brushless motor according to any one of the above (1) to (7), wherein the rotor base has a plurality of through holes through which a part of the first bearing is exposed in the axial direction.
(9)

The brushless motor according to the above (2), further comprising:
a shaft formed to be integrated with the rotor base; and
a stator base configured to support the stator core, the stator base having a cylindrical portion through which the shaft is inserted,
wherein the first bearing and the second bearing are supported by an inner peripheral surface of the cylindrical portion and rotatably support the shaft.
(10)

The brushless motor according to the above (1), wherein the rotor base is disposed inside the stator core.

### REFERENCE SIGNS LIST

1 BRUSHLESS MOTOR
10 SHAFT
20 ROTOR BASE
20a THROUGH HOLE
30 MAGNET
40 STATOR BASE
41 CYLINDRICAL PORTION
41a OUTER PERIPHERAL SURFACE
41a1 FIRST PORTION
41a2 SECOND PORTION
41a3 THIRD PORTION
41a4 FIRST STEP PORTION
41a5 SECOND STEP PORTION
41b INNER PERIPHERAL SURFACE
50 STATOR CORE
60 FIRST BEARING
70 SECOND BEARING
80 RETAINING MEMBER

1. A brushless motor comprising:
a rotor base configured to support a magnet;
a stator core disposed to face the magnet in a radial direction; and
a first bearing and a second bearing configured to rotatably support the rotor base directly or indirectly,
wherein the stator core is disposed between the first bearing and the second bearing in an axial direction.

2. The brushless motor according to claim 1, wherein the rotor base is disposed outside the stator core.

3. The brushless motor according to claim 2, further comprising:
a shaft formed to be integrated with the rotor base; and
a stator base configured to support the stator core, the stator base having a cylindrical portion through which the shaft is inserted,
wherein the first bearing is supported by an outer peripheral surface of the cylindrical portion and rotatably supports the rotor base, and
wherein the second bearing is supported by an inner peripheral surface of the cylindrical portion and rotatably supports the shaft.

4. The brushless motor according to claim 3,
wherein the outer peripheral surface of the cylindrical portion includes a first portion having an outer diameter larger than an inner diameter of the stator core, a second portion having an outer diameter smaller than the inner diameter of the stator core, and a first step portion located between the first portion and the second portion, and
wherein the stator core is supported so as to be in contact with the first step portion.

5. The brushless motor according to claim 4,
wherein the second portion has the outer diameter larger than an inner diameter of the first bearing,
wherein the outer peripheral surface of the cylindrical portion includes a third portion having an outer diameter smaller than the inner diameter of the first bearing, and a second step portion located between the second portion and the third portion, and
wherein the first bearing is supported so as to be in contact with the second step portion.

6. The brushless motor according to claim 3, further comprising a retaining member located on a surface of the second bearing, the surface is located opposite the first bearing, and configured to prevent the shaft from coming off.

7. The brushless motor according to claim 6, wherein the retaining member applies preload to the first bearing and the second bearing.

8. The brushless motor according to claim 1, wherein the rotor base has a plurality of through holes through which a part of the first bearing is exposed in the axial direction.

9. The brushless motor according to claim 2, further comprising:
a shaft formed to be integrated with the rotor base; and
a stator base configured to support the stator core, the stator base having a cylindrical portion through which the shaft is inserted,
wherein the first bearing and the second bearing are supported by an inner peripheral surface of the cylindrical portion and rotatably support the shaft.

10. The brushless motor according to claim 1, wherein the rotor base is disposed inside the stator core.
